(19) United States
(12) Patent Application Publication
(10) Pub. No.: US 2011/0049200 A1
(43) Pub. Date: Mar. 3, 2011

(54) PROMOTIONAL DISPLAY GARMENT HANGER

(76) Inventor: JON CURTIS RODBERG, Laguna Niguel, CA (US)

(21) Appl. No.: 12/836,024

(22) Filed: Jul. 14, 2010

Related U.S. Application Data
(60) Provisional application No. 61/275,589, filed on Sep. 1, 2009.

(51) Int. Cl. A47G 25/14; B31B 1/14

(52) U.S. Cl. 223/85; 493/340

(57) ABSTRACT

Provided is a method of co-marketing and co-selling a garment and related items. The method includes providing a corrugated sheet having opposing inner and outer surfaces. The corrugated sheet is printed and cut to define a custom shape including a first half and a second half collectively defining a display tool. An apparel display portion is formed on the display tool for displaying the wearing apparel and a merchandise display portion is formed on the display tool for displaying the merchandise item. The inner surface of the first half is connected to the inner surface of the second half to define the display tool. This product may be used as a sales and marketing tool in order to enhance the sales performance for apparel and hard goods. The display tool supports a gift with purchase, and also may be used for advertising, promotion and an in-store display.

### CROSS-REFERENCE TO RELATED APPLICATIONS

This application claims the benefit of U.S. Provisional Application No. 61/275,589, filed Sep. 1, 2009.

### STATEMENT RE: FEDERALLY SPONSORED RESEARCH/DEVELOPMENT

Not Applicable

### BACKGROUND

The present invention relates generally to a method and apparatus for marketing and selling all forms of wearing apparel combined with hard goods and other related items, and more specifically, to a hanger configured to display the wearing apparel and the related items, as well as a method for making and using the hanger.

Individuals oftentimes memorialize special events by purchasing a souvenir or keepsake. Souvenirs are typically offered for sale at a gift store and may include a wide range of products. For instance, an amusement park may have a gift store for its guests and offer wearing apparel, such as t-shirts, sweatshirts, and hats, as well as other items including post cards, videos, magnets and the like. Souvenirs may also be offered for sale at a golf course clubhouse to memorialize a round of golf at a prestigious golf club. The clubhouse may sell golf shirts, golf balls, tees, divot repair tools, ball spotters, etc. Souvenirs may additionally be sold at sporting events, school campuses, conventions, malls, airports, and other locations known in the art.

Wearing apparel is a top seller in many gift stores. Consumers oftentimes enter the gift store with a particular garment in mind that they would like to purchase. Once they find the garment, the consumer tends to pay for the garment and then quickly exit the store without further browsing. In this regard, the consumers frequently overlook or miss items which they would otherwise purchase had the consumer noticed the items. In the case of the country club mentioned above, golfers are typically inclined to purchase a golf shirt as a souvenir. Once the golfer finds the golf shirt, he tends to quickly pay for the shirt without browsing for other items, such as golf balls, divot repair tools, etc. Alternatively, another concern is that consumers may spend too much time in the store trying to find all the items they are looking for, which may be undesirable when the gift store is busy, such as during a holiday weekend at an amusement park. It would be desirable to organize the store to mitigate the aforementioned concerns.

The operator of the gift store aims at maximizing the revenues generated by the gift store by selling the wearing apparel, as well as the related items. When consumers overlook the related items, the operator of the gift store loses out on additional revenues. Furthermore, when the consumer spends additional time browsing through the store to find related items, the efficiency of the store may be diminished, especially at busy times, as mentioned above.

Therefore, in view of the foregoing, there is a need in the art for a method and apparatus of marketing and selling wearing apparel as well as other related items. The present invention addresses these particular needs, as will be discussed in more detail below.

### BRIEF SUMMARY

There is provided a method of co-marketing and co-selling a garment and related items on a single display device, such as a hanger. The hanger may be configured to display a variety of garments (i.e., t-shirts, pajama sets, lingerie, dresses, blouses, pants, shorts, sporting/fitness apparel, swimwear, collared shirts, sweatshirts, beach sandals, etc.) coupled with a promotional item(s) such as a toy figurine, action figure, or any number of complementing product lines. The hanger may provide several opportunities to mix and match complimentary products and place them on a single hanger.

The method includes providing a corrugated sheet having an inner surface and an opposing outer surface. The corrugated sheet is first printed, then cut by a display tool to define a custom shape including a first half and a second half collectively defining the display tool. The first half may be separate from the second half, or hingedly connected to the second half. An apparel display portion is then formed on the display tool for displaying the wearing apparel, and a merchandise display portion is formed on the display tool for displaying the merchandise item. The inner surface of the first half is connected to the inner surface of the second half to define the display tool.

The method may additionally include forming a first aperture in the first half, wherein the first aperture extends from the inner surface to the outer surface and is sized to receive the merchandise item. The method may further include forming a second aperture within the second half, wherein the second aperture extends from the inner surface to the outer surface. A first package half may be disposed within the first aperture and a second package half may be disposed within the second aperture, wherein the first package half and second package half collectively define a package enclosure.

The corrugated sheet may include a plurality of corrugations extending along a corrugation axis. The corrugated sheet may be cut such that the first half defines a first bottom edge and the second half defines a second bottom edge, the first bottom edge and the second bottom edge are angularly offset from the corrugation axis. According to one implementation, the first bottom edge and second bottom edge are offset from the corrugation axis by approximately 45 degrees.

In addition to the foregoing, there is also provided a hanger for marketing a merchandise item along with wearing apparel. The hanger includes a first half having an inner surface, an outer surface, and a first aperture formed within the first half and extending from the inner surface to the outer surface, wherein the first aperture is sized to receive the merchandise item. The hanger additionally includes a second half having an inner surface and an outer surface, wherein the inner surface of the first half is connected to the inner surface of the second half to collectively define the hanger. The hanger includes a body portion, a hook portion connected to the body portion, and a pair of opposed apparel arms extending from the body portion for supporting the wearing apparel. A packing element is disposed within the first aperture and is configured to receive the merchandise item.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a hanger displaying a garment for sale, in addition to marketing and displaying related items for sale;

FIG. 2 is a front view of the hanger depicted in FIG. 1;

FIG. 3 is a rear view of the hanger depicted in FIGS. 2;

FIG. 4 is a side view of the hanger depicted in FIGS. 2 and 3;

FIG. 5 is an upper perspective view of a corrugated sheet with the hanger being cut out of the corrugated sheet;

FIG. 6 is an exploded view of the hanger, a plurality of packing elements and related golf accessories for sale; and

FIG. 7 is a front view of another embodiment of a hanger depicting an aquatic image and including related aquatic memorabilia for display.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

Referring now to the drawings, there is depicted a method and apparatus for co-marketing and co-selling wearing apparel and related merchandise items on a single device 10, such as a hanger. The hanger 10 may be used to sell t-shirts, pajama sets, lingerie, dresses, blouses, pants, shorts, sporting/fitness apparel, swimwear, collared shirts, sweatshirts, beach sandals, etc, along with promotional items such as sporting accessories, memorabilia, toy figurines, action figures, or any number of complementing goods. The hanger 10 may offer unlimited possibilities to mix and match complimentary products and place them into a one-piece hanger 10, which may increase the price point and profit margins while moving greater amounts of inventory. The hanger 10 may be employed by club stores, retail stores, advertising agencies, movie promotions, charity promotions, military support, travel and tourism promotions, sports and sporting goods, special events (i.e., concerts), TV show promotions, holiday promotions (i.e., Christmas, Hanukah, Valentine's Day, Mother's Day, Father's Day, Easter, 4^{th} of July, Back to School, Halloween, Birthday's, etc), or any interested party to be used as a gift with purchase.

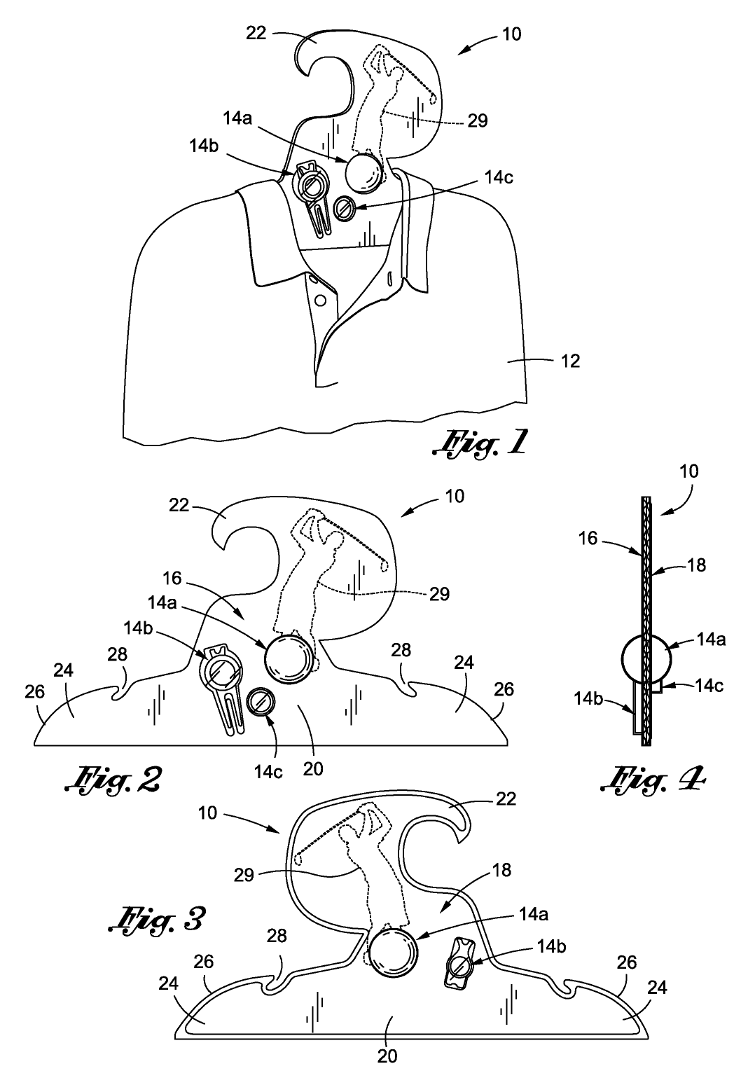

Turning now specifically to FIGS. 1-4, there is depicted a hanger 10 for co-marketing and co-selling a shirt 12 and associated items 14a, 14b, 14c. In the exemplary embodiment illustrated in FIGS. 1-4, the shirt 12 is a golf shirt and the associated items 14a, 14b, 14c include a golf ball, divot repair tool, and a ball marker. It is contemplated that the hanger 10 may be used in the gift shop of a country club with the name and logo of the country club embroidered on the shirt 12 and emblazoned on the items 14a, 14b, 14c. Alternatively, the hanger 10 may be used in a sporting goods store with the name and logo of a golf manufacturer depicted on the shirt 12 and items 14a, 14b, 14c. Of course, the hanger 10 may be used to sell other apparel items and related merchandise packaged therein (i.e., amusement park souvenirs, athletic souvenirs, collegiate merchandise, etc). By packaging the items 14a, 14b, 14c with the shirt 12, the consumer is more likely to purchase the items 14a, 14b, 14c than if they were sold separately, thereby creating additional revenues for the seller. Furthermore, the integrated packaging creates an appearance which immediately captures the attention of the consumer. In this manner, the hanger 10 advantageously markets the items 14a, 14b, 14c at the point of sale of the shirt 12.

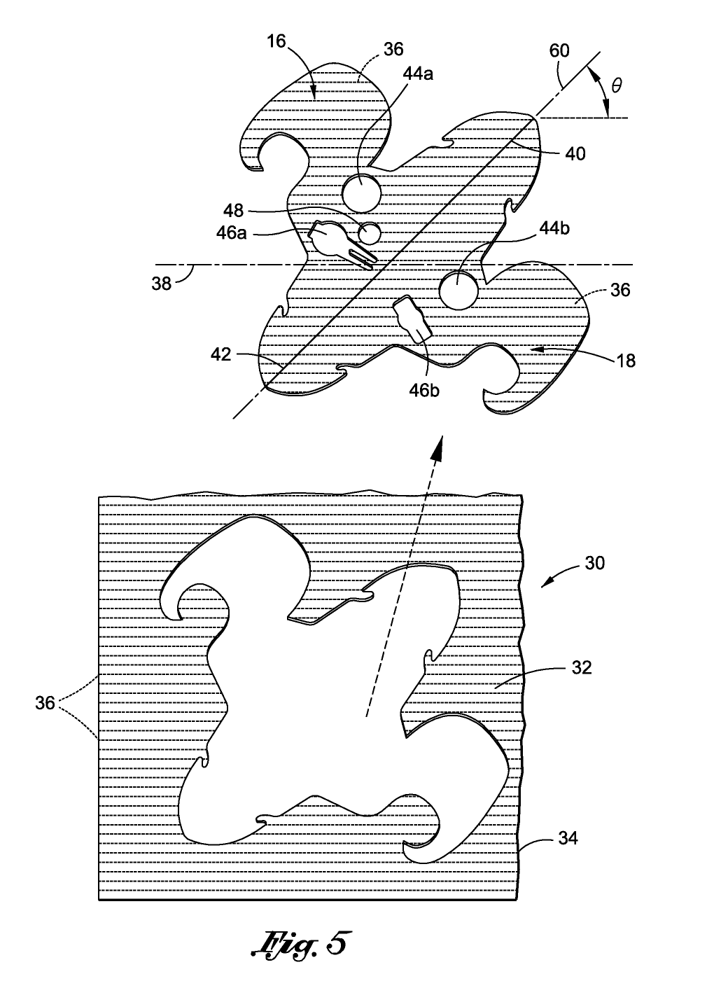

According to one embodiment, the hanger 10 is formed out of a corrugated material and includes a first half 16 (see FIG. 4) and a second half 18 (see FIG. 4). The first half 16 and second half 18 are complimentary and are configured to be connected to each other to collectively define the hanger 10. FIG. 2 is a front view of the hanger 10 showing the first half 16, while FIG. 3 is a rear view of the hanger 10, primarily depicting the second half 18. FIG. 4 is a side view depicting the first half 16 connected to the second half 18.

The hanger 10 may define a traditional hanger shape and includes a body portion 20 (see FIGS. 2 and 3), a hook portion 22 extending from the body portion 20, and a pair of opposed arms 24 (see FIGS. 2 and 3) extending from the body portion 20. The hook portion 22 is configured to enable the hanger 10 to be hung from a conventional display rack, while the arms 24 are configured to support the wearing apparel 12 for display. As shown, each arm 24 is generally elongate and includes a curved end portion 26 (see FIGS. 2 and 3) for “hanging” the shirt 12, and notches 28 (see FIGS. 3 and 4) for maintaining the shirt 12 on the hanger 10. The hanger 10 may be available in different sizes for use with various types and sizes of wearing apparel 12.

The hanger 10 additionally includes a plurality of apertures formed within the first half 16 and the second half 18 for receiving and displaying the items 14. The apertures may be sized to accommodate the various items 14 which may be marketed and sold with the garment 12. Packing elements, such as plastic blister packs, may be disposed within the apertures for securing the items to the hanger 10 and to protect the items when on display.

According to one implementation, the hanger 10 includes graphics 29, logos, or other indicia printed or laminated on the front and/or back of the hanger 10. The graphics 29 may be printed with hi-resolution 4 color graphics to promote brand awareness and to gain the visual attention of consumers in an area of a retail store which may not include such advertising. The graphics 29 may be associated with the apparel 12 and items 14 displayed and offered for sale. For instance, the graphic 29 depicted in FIGS. 1-4 includes a golfer on the front (FIGS. 1 and 2) of the hanger 10, as well as on the back (FIG. 3) of the hanger 10. The image of the golfer is complimentary to the golf shirt 12 and golf items 14 displayed on the hanger 10. The graphics 29 may additionally include the logo of the garment and/or item manufacturer, which tends to enhance the brand awareness of the manufacturer. It is further contemplated that the graphics 29 may include special offers or promotional descriptions of the items 14 offered for sale.

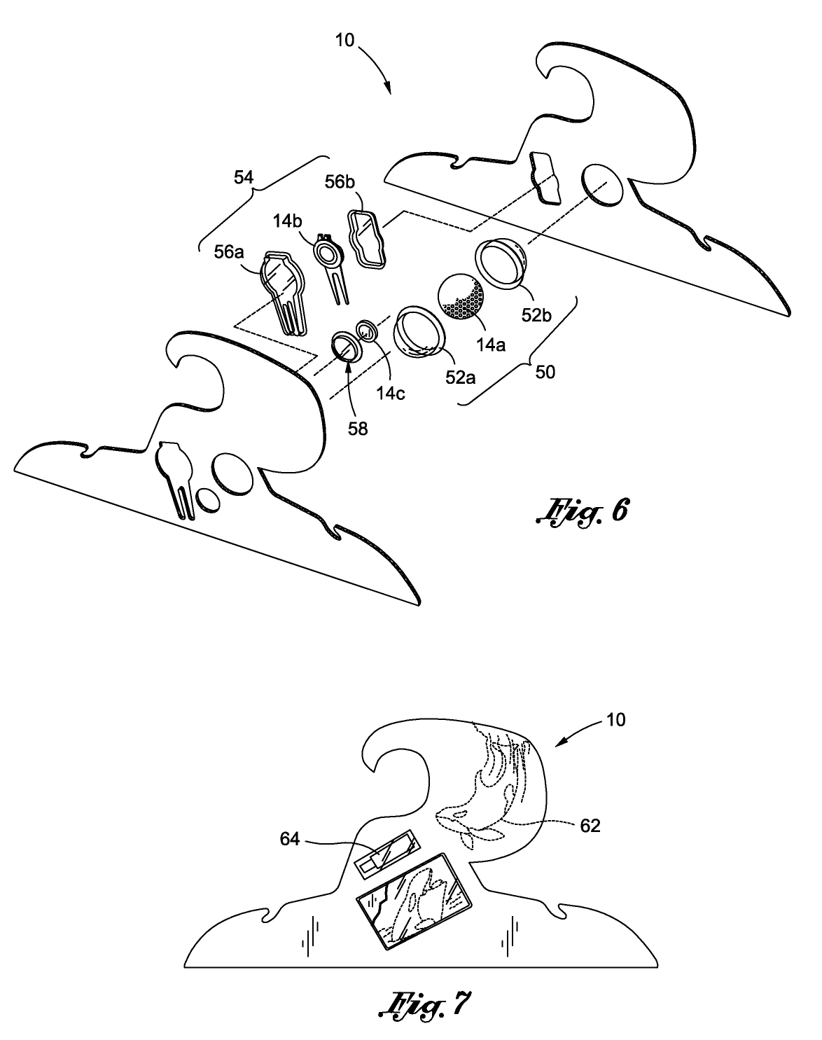

With the basic structure of the hanger 10 being described above, the following discussion primarily pertains to methods of forming the hanger 10 and using the hanger 10. Referring now to FIGS. 5-7, and according to one embodiment, the hanger 10 is formed out of a corrugated sheet 30 including an inner surface 32 and an outer surface 34. The hanger 10 is cut out of the corrugated sheet 30, with the first half 16 and second half 18 preferably being cut from the sheet 30 in one piece (as is depicted in FIG. 5). In other words, the first half 16 and second half 18 are integrally attached to each other with a butterfly fold in the middle when the hanger 10 is cut from the corrugated sheet 30. However, it is contemplated that the first half 16 and second half 18 may be cut out separately and subsequently attached. The hanger 10 may be cut from the corrugated sheet 30 with a die cutting tool or by other cutting methods known by those skilled in the art.

The corrugated sheet 30 includes a plurality of corrugations 36 or flutes that extend along a corrugation axis 38 (see FIG. 5). The hanger 10 may be cut from the corrugated sheet 30 such that the corrugations 36 extend diagonally across the first half 16 and the second half 18 (see FIG. 5) to enhance the strength and durability of the hanger 10. In particular, the first half 16 may define a first bottom edge 40 and the second half 18 may define a second bottom edge 42. The corrugations 36 may extend angularly from the bottom edges to define an angle θ of approximately 45 degrees, although other angles may be defined without departing from the spirit and scope of the present invention.

Once the first half 16 and second half 18 are cut from the corrugated sheet 30, the apertures are formed therein. The size and configuration of the apertures correspond to and are complimentary to the items 14 intended to be disposed therein. For instance, the hanger 10 depicted in FIGS. 1-6 is configured to display a golf ball 14a, a divot repair tool 14b and a golf ball marker 14c. Therefore, the apertures formed within the hanger 10 are sized to receive the respective items and are complimentary to their shape.

Apertures 44a, 44b are complimentary in shape to the golf ball 14a and extend through the first half 16 and the second half 18, respectively. In particular, aperture 44a extends from the inner surface 32 to the outer surface 34 on the first half 16, while aperture 44b extends from the inner surface 32 to the outer surface 34 on the second half 18. Furthermore, given the spherical shape of the golf ball 14a, the size and shape of the aperture 44a is substantially identical to the size and shape of aperture 44b. The apertures 44a, 44b are formed such that when the first half 16 and second half 18 are attached, the apertures 44a, 44b are aligned and overlap to receive and display the golf ball 14a.

Apertures 46a, 46b are complimentary in shape to the divot repair tool 14b. Aperture 46a extends through the first half 16 from the inner surface 32 to the outer surface 34, and aperture 46b extends through the second half 18 from the inner surface 32 to the outer surface 34. Given the unique shape of the divot repair tool 14b, aperture 46a may define a different size and configuration than aperture 46b. The apertures 46a, 46b are sized and positioned such that when the first half 16 and second half 18 are attached, the apertures 46a, 46b are aligned and overlap to accommodate the divot repair tool 14b.

Aperture 48 is formed within the first half 16 for displaying the ball marker 14c. Aperture 48 extends through the first half 16 from the inner surface 32 to the outer surface 34. It is important to note that aperture 48 does not extend through the second half 16. The ball marker 14c is relatively thin and therefore may only require a single aperture within the hanger 10 for display.

Packing elements, such as conventional plastic blister packs, may be used to secure the items 14a, 14b, 14c within the respective apertures. The packing elements may be transparent to allow a consumer to see the items 14a, 14b, 14c. The packing elements may also be complimentary in shape to the respective items 14a, 14b, 14c, as well as the apertures within which the packing elements are disposed.

Packing element 50 is used to secure the golf ball 14a within apertures 44a, 44b. Packing element 50 includes a first half 52a and a second half 52b which collectively define an enclosure sized to store the golf ball 14a. The first half 52a of the packing element 50 is disposed within aperture 44a, while the second half 52b of the packing element 50 is disposed within aperture 44b. Given the spherical shape of the golf ball 14a, the first half 52a and second half 52b of the packing element 50 may be substantially identical. The first half 52a and second half 52b of the packing element 50 may be secured to each other by an adhesive or by welding to enclosure the golf ball 14a therein.

Packing element 54 is used to secure the divot repair tool 14b to the hanger 10, and includes a first half 56a and a second half 56b. The size and shape of the first half 56a differs from the size and shape of the second half 56b in order to accommodate the unique size and shape of the divot repair tool 14b. The first half 56a is disposable within aperture 46a, while the second half 56b is disposable within aperture 46b. The first half 56a and second half 56b may be joined by an adhesive, by welding or by other means known by those skilled in the art.

Packing element 58 is configured to secure the ball marker 14c to the hanger 10. The packing element 58 is disposable within aperture 58 and engages with the inner surface 32 of the second half 18 of the hanger 10. In this manner, packing element 58 and the inner surface 18 of the second half 18 of the hanger 10 collectively define an enclosure for displaying the ball marker 14c. Packing element 58 may be secured to the hanger 10 by an adhesive or by other attaching techniques known in the art.

Once the apertures are formed and the various packing elements are disposed within their respective apertures, the first half 16 and second half 18 of the hanger 10 may be folded toward each other about a fold axis 60 to connect the inner surface 32 of the first half 16 to the inner surface 32 of the second half 18. Prior to the folding step, the packing elements may also be prepared for attachment to the corresponding packing element half, or to the hanger 10, as described in more detail above, such that when the first and second halves 16, 18 of the hanger 10 are folded, the packing elements engage with their respective mate to secure the respective item therein.

A heat activated adhesive may be disposed along or laminated to the inner surface 16 of the hanger 10 for attaching the first half 16 to the second half 18. The inner surface 32 may be heated immediately before folding the first half 16 and second half 18 together. Alternatively, the first and second halves 16, 18 may be laminated together once they are folded to define the hanger 10. It is also contemplated that other adhesives or joining means may be employed without departing from the spirit and scope of the present invention.

By integrating the items 14a, 14b, 14c into the hanger 10, the consumer is more likely to purchase the additional items with the garment 12. The seller may give the consumer the option of purchasing the garment 12 by itself, or the items 14a, 14b, 14c by themselves, although it is likely that consumers will be enticed by the innovative display and convenience of the integrated design so as to purchase the garment 12 and the items 14a, 14b, 14c.

Although FIGS. 1-6 depict a hanger 10 for displaying and selling a golf shirt 12 and golf items 14, it is understood that the hanger 10 may be used in other industries. Referring now to FIG. 7, there is depicted another embodiment of the hanger 10 configured for use to sell memorabilia at an amusement park. The hanger 10 includes a graphic 62 of an aquatic animal, which may be featured at the amusement park. The items displayed within the hanger 10 include a USB drive 64 and a magnet 66. The USB drive 64 may include a video file of the aquatic animal stored thereon for replay by the consumer. Furthermore, the magnet 66 depicts an image of the aquatic animal shown in the graphic 62.

Other exemplary uses of the hanger 10 include using the hanger 10 to market and sell the following children's items: a costume with costume jewelry; a dinosaur/animal shirt with matching toy figurines; a movie shirt with a movie figurine; camping apparel with a flashlight; a car racing shirt with a toy car; a shirt with lip gloss or chap stick; a bathing suit with sunscreen, goggles or pool toys; a science shirt with play dough or ooze; and a sports shirt with a ball, a mouth guard or sweatbands. The hanger 10 may be used to market and sell the following teen-related items: shirts with a mini digital camera; shirts with a USB drive; shirts with school supplies; music related apparel with CD's or digital music; surf trunks with surfboard wax or wax comb; and work-out gear with a club accessory. The following items may be marketed toward women using the hanger 10: a cooking apron with cooking utensils; dresses with jewelry and other accessories; blouses with body lotions or perfumes; and sandals with sunscreen, nail clippers, bottle openers or playing cards. The hanger 10 may be used to market and sell the following items to men: golf apparel with golf balls or accessories; baseball shirts with a baseball; a Father's Day shirt with tools; and a sports team jersey with a key chain. The hanger 10 also provides the following corporate promotional opportunities: a branded beer shirt with a bottle opener; branded car shirts with key chains; a Swiss army shirt with a Swiss army knife, a branded camping shirt with a mini flashlight; and branded candy company shirt with a candy dispenser. The foregoing examples are exemplary in nature only and are not intended to limit the scope of usage of the hanger 10. Furthermore, it is understood that the hanger 10 may be used to display items other than apparel, such as curtains, fabrics, or other items commonly displayed on a hanger.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of marketing wearing apparel and a corresponding merchandise item, the method comprising the steps of:
a) providing a corrugated sheet having an inner surface and an opposing outer surface;
b) cutting the corrugated sheet to define a display tool including a first half and a second half collectively defining the display tool;
c) forming an apparel display portion on the display tool for displaying the wearing apparel;
d) forming a merchandise display portion on the display tool for displaying the merchandise item; and
e) connecting the inner surface of the first half to the inner surface of the second half to define the display tool.

2. The method recited in claim 1, wherein step d) includes forming a first aperture in the first half, the first aperture extending from the inner surface to the outer surface, the first aperture being sized to receive the merchandise item.

3. The method recited in claim 2, wherein step d) includes forming a second aperture within the second half, the second aperture extending from the inner surface to the outer surface.

4. The method recited in claim 3, further comprising the step of disposing a first package half within the first aperture and a second package half within the second aperture, the first package half and second package half collectively defining a package enclosure.

5. The method recited in claim 4, further comprising the step of disposing a merchandise item within the package enclosure.

6. The method recited in claim 5, further comprising the step of connecting the first package half to the second package half.

7. The method recited in claim 3, wherein the second aperture at least partially overlaps with the first aperture when the first half is connected to the second half.

8. The method recited in claim 7, wherein the second aperture defines a shape which is substantially identical to the first aperture.

9. The method recited in claim 3, wherein the second aperture is spaced from the first aperture.

10. The method of claim 2, further comprising the steps of:
providing a packing element disposable within the first aperture, the packing element and the inner surface of the second half defining a package enclosure; and
disposing the merchandise item within the package enclosure.

11. The method of claim 10, further comprising the step of connecting the packing element to the second half.

12. The method of claim 1:
wherein step a) includes providing a corrugated sheet having a plurality of corrugations extending along a corrugation axis; and
wherein step b) includes cutting the corrugated sheet such that the first half defines a first bottom edge and the second half defines a second bottom edge, the first bottom edge and the second bottom edge being angularly offset from the corrugation axis.

13. The method of claim 12, wherein the first bottom edge and second bottom edge are offset from the corrugation axis by approximately 45 degrees.

14. The method of claim 1, wherein step e) includes folding the first half and second half about a fold axis to connect the inner surface of the first half to the inner surface of the second half.

15. The method of claim 14, further comprising the step of disposing an adhesive between the first half and second half to connect the inner surface of the first half to the inner surface of the second half.

16. A hanger for marketing a merchandise item along with wearing apparel, the hanger comprising:
a first half having an inner surface, an outer surface, and a first aperture formed within the first half and extending from the inner surface to the outer surface, the first aperture being sized to receive the merchandise item;
a second half having an inner surface and an outer surface, the inner surface of the first half being connected to the inner surface of the second half to collectively define the hanger, the hanger including a body portion, a hook portion connected to the body portion, and a pair of opposed apparel arms extending from the body portion for supporting the wearing apparel; and
a packing element disposed within the first aperture, the packing element being configured to receive the merchandise item.

17. The hanger of claim 16, wherein the first half defines a first bottom edge and the second half defines a second bottom edge, the first half and the second half being formed of a corrugated material having a plurality of corrugations extending along a corrugated axis, the first bottom edge and the second bottom edge being angularly offset from the corrugated axis by approximately 45 degrees.

18. The hanger of claim 16, wherein the packing element and the inner surface of the second half collectively define a packing enclosure sized to receive the merchandise item.

19. The hanger of claim 16, wherein the body portion of the second half includes a second aperture formed therein, the second aperture overlapping the first aperture, the second aperture being sized to receive the merchandise item.

20. The hanger of claim 19, wherein the packing element includes a first half disposed within the first aperture and a second half disposed within the second aperture, the first half and second half collectively defining a packing enclosure sized to receive the merchandise item.
